(19) United States
(12) Patent Application Publication
(10) Pub. No.: US 2007/0234589 A1
(43) Pub. Date: Oct. 11, 2007

(54) Pressurized Drying/Dehydration Apparatus and Method

(76) Inventors: Peter Bernegger, West Point, MS (US); Roland Banks, Salisbury, MD (US)

Correspondence Address: WILSON DANIEL SWAYZE, JR., 3804 CLEARWATER CT., PLANO, TX, 75025, US

(21) Appl. No.: 11/697,020

(22) Filed: Apr. 5, 2007

Related U.S. Application Data
(60) Provisional application No. 60/744,340, filed on Apr. 5, 2006.

(51) Int. Cl. F26B 5/04; F26B 3/00

(52) U.S. Cl. 34/413; 34/443

(57) ABSTRACT

A method for drying feed material includes transporting the feed material along, inside, a pressurized line, pressurizing the feed material, inputting the feed material, removing the feed material from the pressurized line. The method includes the step of varying a residence time of the feed material in the pressurized line, the step of varying a pressure within the pressurized line, the step of varying a temperature of the pressurized line, the step of varying a length of the pressurized line, and the step of varying a diameter of the pressurized line.

### PRIORITY

The present invention claims priority under 35 USC section 119 based upon provisional application filed on Apr. 5, 2006 with Ser. No. 60/744,340.

### FIELD OF THE INVENTION

The present invention relates to a pressurized drying/dehydration method and apparatus.

### BACKGROUND OF THE INVENTION

Controlling the amount of moisture in raw material feed is important. For example, in human foods the shelf life and longevity can be greatly extended. Also, transportation and packaging costs can be greatly reduced. Another instance is in the breeding of animals, it is of economic importance that the animals obtain feed which does not only contain correctly adapted nutritive substances but is also given in correct amounts, thereby maximizing the growth per kilogram of consumed feed. However, it has been found difficult in the administration of dry animal feed to calculate the active content in the animal feed owing to varying water content. Variations in the water content of more than 2% from the desired value are not unusual. When breeding mink and fox, it is also important that the dry animal feed mixtures contain a considerable amount of water, thereby reducing the risk of dehydration in cold weather.

It has also been found that wet moisture in various feeds can cause difficult problems, such as caking, bacterial growth, mold yeast and the breaking down of nutrients.

### SUMMARY OF THE INVENTION

The object of the present invention therefore is to provide a method and apparatus of preparing wet feed material to a dry state or similar with low moisture content. It is another object of the invention to provide a method and apparatus to vary the parameters associated with the drying of the various feed materials to change and control the desired moisture content of the feed material.

The present invention allows moisture to be controllably removed from various feed materials and achieves larger throughput per unit of time than is currently possible with other prior art technology.

The present invention includes an air compressor or air compression with a velocity apparatus.

At the discharge outlet of the air compressor or air compression with velocity apparatus, an feed line inlet to a pressurized line is formed. The feed line inlet can take the form of the valve with a pump for feed material that can be pumped or an airlock for a system used for lower moisture solid type feed materials. Other devices can introduce the feed material into the pressurized line.

The pressurized line may be varied in length to be very short or very long, and the internal pressure of the pressurized line is maintained throughout the line by a nozzle or nozzles formed at the end or along the line. The pressure is then reduced to atmospheric pressure or near atmospheric pressure so that the feed material can be removed from the pressurized line.

A chamber can be used along the feed line to increase the residence time in the pressurized line. These chambers may be referred to as reactors or compartments.

As an example, a 90% moisture feed material can be input into the pressurized line inlet at a relatively high rate of feed, and in short amount of time, which may be measured in seconds, a dry powder can be removed from the final outlet separated from either hot steam and or water vapor.

The present invention is a drying system which can be configured to be a dehydrated system.

The variables of the present invention can be dynamically changed to produce different end results. For example, the moisture content of the end product can be lowered or increased depending on the needs of the user. The line pressure can be adjusted to be either higher or lower. A higher line pressure results in more possible energy storage per cfm unit. Conversely, a lower line pressure results less possible energy storage per cfm unit.

The temperature of the line can be varied to a higher temperature resulting in a dryer product and can be varied to a lower temperature resulting in a product with a higher moisture content.

The residence time which is the elapsed time that the feed material remains within the line can be varied with a longer residence time resulting in a product which is dryer and a shorter residence time resulting in a product which is moister.

The line pressure can be varied in accordance with the operation of the air compressor. The air compressor can provide a line pressure between 10 psi or as high as 50,000 psi.

The line temperature can be varied by modifying the air compressor by modifying the horsepower and size of the air compressor between 50 cfm and 50,000 cfm.

The temperature can be varied by adding either hot or cold air or various gas mixtures to the line at various predetermined positions along the length of the line. The temperature can be varied by adding various devices to increase or decrease the temperature of the air/gas in the pressurized line. The temperature can be varied by chemical reactions in the pressurized line or introduced into the feed line.

The residence time which is the time the feed material remains within the pressurized line can be increased or decreased by changing several variables. The length of the pressurized line can be increased to increase the residence time, decreasing the length of the pressurized line decreases the residence time. The diameter of the pressurized line can be increased to increase the residence time, decreasing the diameter of the pressurized line decreases the residence time. A longer residence time results in the feed material becoming dryer, and a shorter residence time results in the feed material becoming moister.

The cfm can be varied for a higher pressure which provides smaller particles. The higher pressure creates a greater explosion out of the nozzle. Correspondingly, a lower pressure provides for larger particles and a lower explosion. The higher pressure increases the capability for additional heat for example in terms of BTUs to be absorbed based upon the cfm which lowers the totals operating costs because of better efficiency.

The present invention utilizes a reactor or chamber in order to increase the residence time. The present invention may shorten the residence time by eliminating the reactor, or chamber, or shunting the feed line around the reactor.

### BRIEF DESCRIPTION OF THE INVENTION

The invention may be understood by reference to the following description taken in conjunction with the accompanying drawings, in which, like reference numerals identify like elements, and in which:

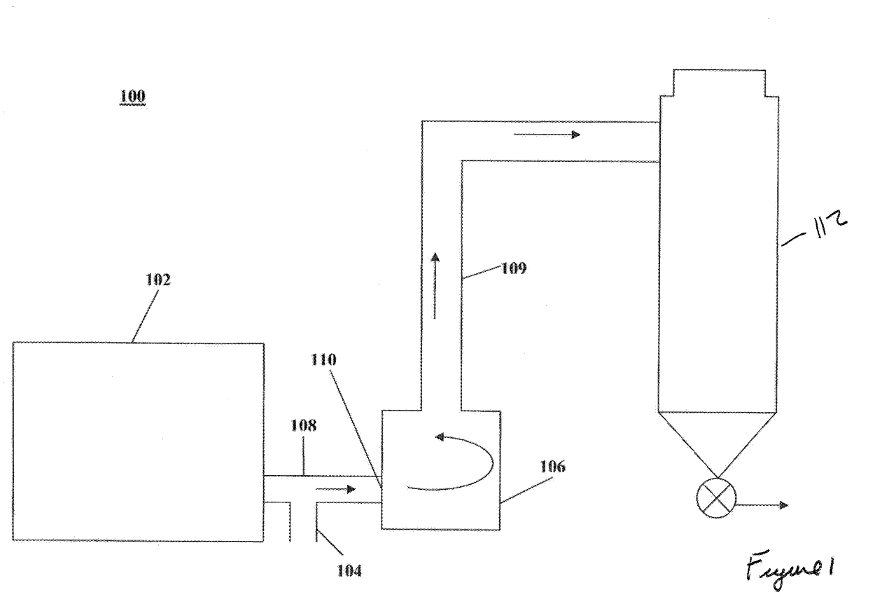

FIG. 1 illustrates the apparatus of the present invention;

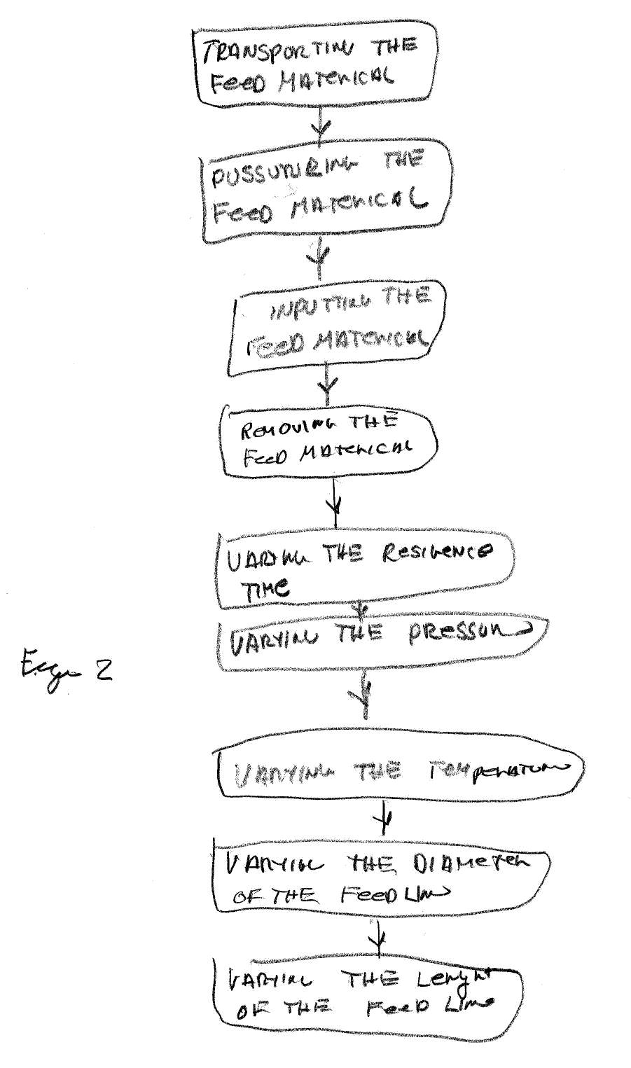

FIG. 2 illustrates the method of the present invention.

### DETAILED DESCRIPTION

The present invention includes an air compressor or air compression with a velocity apparatus.

FIG. 1 illustrates the pressurized drying/dehydration apparatus 100 of the present invention. At the discharge outlet of the air compressor 102 or air compression with velocity apparatus, a feed line inlet 104 is positioned to input feed material into a pressurized line 108. The pressurized line 108 may be a hose, pipe, tubing or other type of chamber. The feed material may be liquid, slurries, wet solids, small particles or other appropriate material. The feed line inlet 104 can take the form of the valve with a pump to input feed material that can be pumped, or the feed line inlet 104 could be an airlock for a system used for inputting lower moisture solid type feed materials. Various devices may be developed to in-feed the wet feed into the pressurized line 108.

The pressurized line 108 may be varied in length to be very short or very long and the internal pressure of the pressurized line 108 is maintained throughout the pressurized line 108 by a nozzle 110. The pressure is then reduced by the nozzle 110 to atmospheric pressure or near atmospheric pressure so that the feed material can be removed from the line 108. An exhaust line 109 is connected to chamber 106 to carry the feed material to the separation device 112 which separates dried powder from the airstream.

A chamber 106 or a plurality of chambers can be used along the pressurized line 108 to increase the residence time in the pressurized line in 108. These chambers and 106 may be referred to as reactors, chambers or compartments. The system 100 of the present invention may utilize high-pressure. The present invention may include a drying device, a dehydrated device, a grinding device, a killing or reducing pathogens, particle reduction piping device, or other suitable devices may be used with or instead of the reactor 106. These same devices may be used in conjunction with the feed inlet device or system line 104.

As an example, a 90% moisture feed material can be input into the feed line inlet 104 at a relatively high rate of feed, and in short amount of time which may be measured in seconds, a dry powder can be removed from the nozzle 110 separated from either hot steam and or water vapor.

The present invention is a drying system which can be configured to be a dehydrated system.

The variables of the present invention can be dynamically changed to produce different end results. For example, the moisture content of the end product can be lowered or increased depending on the needs of the user. The line pressure of the line 108 can be adjusted to be either higher or lower. A higher line pressure results in a dryer product, and conversely, a lower line pressure results in a product with more moisture.

The temperature of the pressurized line 108 can be varied to a higher temperature resulting in a dryer product, and the temperature of the pressurized line 108 can be varied to a lower temperature resulting in a product with higher moisture content.

The residence time which is the elapsed time that the feed material remains within the line 108 can be varied with a longer residence time resulting in a product which is dryer and a shorter residence time resulting in a product which is moister.

The line pressure of the line 108 can be varied in accordance with the operation of the air compressor 102. The air compressor 102 can provide a line pressure between 10 psi or as high as 50,000 psi.

The line temperature can be varied by modifying the air compressor 102 by modifying the horsepower and size of the air compressor 102 between 50 cfm and 50,000 cfm.

The temperature of the line 108 can be varied by adding either hot or cold air or various gas mixtures to the line at various predetermined positions along the length of the line the 108. The temperature can be varied by using employing devices to heat or cool air or gas in line 108. Chemical reactions can also be employed to heat or cool air or gas in line 108.

The residence time which is the time the feed material remains within the pressurized line 108, and the residence time can be increased or decreased by changing several variables. The length of the pressurized line 108 can be increased to increase the residence time, decreasing the length of the pressurized line 108 decreases the residence time. The diameter of the pressurized line 108 can be increased to increase the residence time, decreasing the diameter of the pressurized line 108 decreases the resident time. A longer residence time results in the feed material becoming dryer, and a shorter residence time results in the feed material becoming moister.

The cfm can be varied for a higher pressure which provides smaller particles. The higher pressure creates a larger explosion out of the nozzle 110 and provide for smaller particles. Correspondingly, a lower pressure provides for larger particles and a lower explosion. The higher pressure increases the capability for additional heat for example in terms of BTUs to be absorbed based upon the cfm which lowers the totals operating costs because of better efficiency.

The present invention utilizes a reactor or chamber 106 in order to increase the residence time. The present invention may shorten the residence time by eliminating the reactor or chamber 106 or by shunting the pressurized line 108 around the reactor 106.

FIG. 2 illustrates the method of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A drying system for drying feed material, comprising:
a feed line for transporting the feed material;
a compressor for pressurizing the pressurized line;
a pressurized line for drying
a feed line input for inputting the feed material; and
a valve connected to the feed line to remove the feed material from the feed line.

2. A drying system for drying feed material as in claim 1, wherein said compressor includes an air compressor.

3. A drying system for drying feed material as in claim 2, wherein said air compressor includes a velocity apparatus.

4. A drying system for drying feed material as in claim 1, wherein said compressor provides a pressure substantially between 10 pounds per square inch (psi) and 50,000 psi.

5. A method for drying feed material, comprising the steps of:
transporting the feed material along a feed line;
pressurizing the feed material;
inputting the feed material;
drying the feed material in the pressurized line
removing the feed material from the pressurized line.

6. A method for drying feed material as in claim 5, wherein, a method includes the step of varying a residence time of the feed material in the pressurized line.

7. A method for drying feed material as in claim 5, wherein a method includes the step of varying a pressure within the pressurized line.

8. A method for drying feed material as in claim 5, wherein the method includes the step of varying a temperature of the pressurized line.

9. A method for drying feed material as in claim 5, wherein the method includes the step of varying a length of the pressurized line.

10. A method for drying feed material as in claim 5, wherein the method includes the step of varying a diameter of the pressurized line.
